(19) United States
(12) Patent Application Publication
(10) Pub. No.: US 2017/0242508 A1
(43) Pub. Date: Aug. 24, 2017

(54) TOUCH DEVICE AND MANUFACTURING METHOD THEREOF

(71) Applicant: Innolux Corporation, Miao-Li County (TW)

(72) Inventors: Shan-Yu WU, Chu-Nan (TW); Chih-Min CHEN, Chu-Nan (TW); Jui-Jen YUEH, Chu-Nan (TW); Hung-Sheng CHO, Chu-Nan (TW); Sheng-Shiou YEH, Chu-Nan (TW)

(73) Assignee: Innolux Corporation, Miao-Li County, TAIWAN

(21) Appl. No.: 15/439,517

(22) Filed: Feb. 22, 2017

(30) Foreign Application Priority Data
Feb. 23, 2016 (CN) 201610098728.1

(51) Int. Cl. G06F 3/044

(52) U.S. Cl. CPC G06F 3/044; G06F 2203/04103; G06F 2203/04112

(57) ABSTRACT

A touch device and a manufacturing method thereof are provided. The touch device includes a base structure and a touch structure. The touch structure includes a touch electrode pattern and a metal trace. The touch electrode pattern is on the base structure. The metal trace is on an edge of the touch electrode pattern. A thickness of the metal trace is 1 μm-100 μm. A roughness of the metal trace is 0.1 μm-90 μm.

This application claims the benefit of People's Republic of China application Serial No. 201610098728.1, filed Feb. 23, 2016, the subject matter of which is incorporated herein by reference.

### BACKGROUND

Field of the Disclosure

The disclosure relates in general to a touch device and a manufacturing method thereof, and more particularly to a touch device with touch traces formed of a rolled metal and a manufacturing method.

Description of the Related Art

Along with the advance in the display technology, various display devices are provided one after another. Of the various display devices, the display device equipped with touch structure has been widely used in various electronic products.

During the manufacturing process of flexible touch display device, layers such as electrode are sequentially formed and patterned. Firstly, a transparent conductive layer and a sputtered metal film are sequentially formed on a flexible substrate formed of plastic (such as polyethylene terephthalate (PET) and polyimide (PI)). Then, the transparent conductive layer and the metal film are patterned to form a transparent electrode pattern and an external trace of the sputtered metal on the substrate. The photolithography patterning process includes many steps such as exposure process, development process, etching process, and baking process. However, if using flexible substrate, the glass transition temperature (Tg) of the plastic substrate is not durable to the high-temperature photolithography process (for example, the glass transition temperature of PET is about 80° C.).

Therefore, when being exposed in the high-temperature photolithography process, the plastic substrate is apt to cause unexpected changes which may deteriorate the performance of the touch display device (such as transmittance). Furthermore, using plastic substrate will increase the thickness of the touch display device and increase cost.

Therefore, it has become a prominent task to resolve the problems encountered in current technologies.

### SUMMARY OF THE DISCLOSURE

The present disclosure is directed to a touch device and a manufacturing method thereof.

In one embodiment of the present disclosure, a touch device is provided. The touch device includes a base structure and a touch structure. The touch structure includes a touch electrode pattern and a metal trace. The touch electrode pattern is on the base structure. The metal trace is on an edge of the touch electrode pattern. The metal trace has a thickness of 1 μm-100 μm and a roughness of 0.1 μm-90 μm. The metal trace can be electrically connected to the touch electrode pattern.

In one embodiment, a manufacturing method of a touch device is provided. The manufacturing method of the touch device includes the following steps. A conductive layer is formed on a metal substrate to form a laminated structure. A base structure is provided. The conductive layer of the laminated structure and the base structure are bonded through a transparent dielectric bonding layer. The metal substrate is patterned to form a metal trace of the touch device. The conductive layer is patterned to form a touch electrode pattern of the touch device.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 to FIG. 8 show a manufacturing method of touch device according to an embodiment;

FIG. 9 is a schematic diagram of a touch device according to another embodiment;

FIG. 10 is a schematic diagram of a touch device according to alternate embodiment.

### DETAILED DESCRIPTION OF THE INVENTION

The present disclosure provides a touch device and a manufacturing method thereof. According to some embodiments, a metal substrate is used as a supporting material layer and is durable to high temperature in the process. In the present disclosure, the metal substrate can also be referred to a metal based film. Since the metal substrate has good supportability, the metal substrate in the present disclosure can also be referred to a metal support. The metal substrate (metal based film) is patterned to form a metal external trace of the touch device. The touch device and the manufacturing method employ simply manufacturing processes, saving materials, reducing the manufacturing cost, and thinning the electronic device. In order for more specific, the technical features of the present disclosure will be more easily understood with the following detailed descriptions and accompanying drawings. However, the present invention is not limited to the following detailed descriptions and drawing.

It should be noted that these embodiments are for exemplification purpose only, not for limiting the scope of protection of the present disclosure. The present disclosure can be implemented by using other features, elements, methods or parameters. The embodiments are merely for illustrating the technical features of the present disclosure, not for limiting the scope of protection of. Anyone skilled in the technology field of the present disclosure will be able to make suitable modifications or changes based on the specification disclosed below without breaching the spirit of the present disclosure. Designations common to the accompanying drawings are used to indicate identical or similar elements.

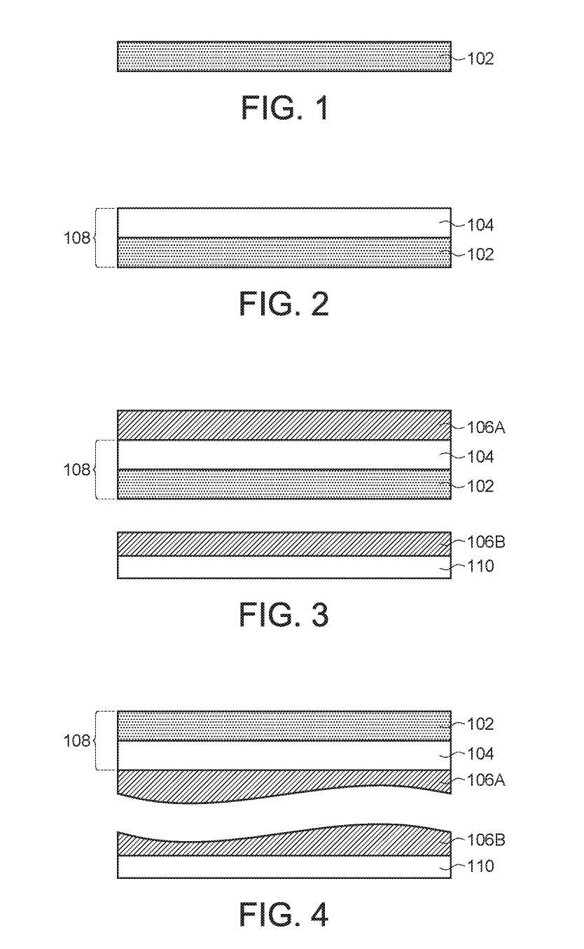

FIG. 1 to FIG. 8 show a manufacturing method of a touch device according to an embodiment.

Referring to FIG. 1, a metal substrate (or referred to a metal based film) 102 is provided. In embodiments, the metal based film 102 can be a metal based film with supportability. Such metal based film can support and directly be used in manufacturing process without additional supporting substrate. The metal based film 102 can be realized by a metal based film formed by a rolling process, that is, a rolled metal film. The metal based film in the present disclosure is suitable to support a conductive layer in subsequent manufacturing process. The metal based film is not limited to the rolled metal based film.

Properties of the rolled metal based film 102 used in embodiments of the present disclosure are different from properties of a metal material formed by using sputtering process or screen printing process. The properties of the metal materials formed by using the sputtering process, the screen printing process and the rolling process are listed in Table 1. In comparison to the rolled metal based film 102, the metal layer formed by using the sputtering process or the screen printing process lacks supportability. Therefore, the metal layer formed by using the sputtering or screen printing cannot be directly used as a based film (or substrate or support) in manufacturing process.

TABLE 1

| | Manufacturing process | | |
|---|---|---|---|
| | Sputtering | Screen printing | |
| Properties | process | process | Rolling process |
| Thickness | <<1 μm | ~10 μm | 1 μm-100 μm |
| Metallurgical | The grains are | Metal particles | The crystal is |
| structure | with a uniform | are coated in a | extended along the |
| | size distribution; | based film. | processing direction; |
| | the crystalline | | both the grain and |
| | structure has | | the inclusion are |
| | a particular | | elongated to have a |
| | direction. | | fibrous shape flat |
| | | | and long. |
| General | The grains are | The paste is | The metal piece is |
| descriptions | with a uniform | made from | heated and physically |
| | size distribution; | resin and metal | rolled to a desired |
| | the crystalline | nano-particles. | thickness, so the |
| | structure has | After post cure, | crystal lattice is |
| | a particular | the film | flat and long in |
| | direction. | contains resin. | texture. |
| Roughness | Smoother; | Rougher; | Moderate roughness; |
| | <<0.1 μm | >>0.1 μm | >0.1 μm |

For example, the manufacturing process of the rolled metal based film 102 includes the following steps. Liquid metal is poured into a mold, then allowed to cool and solidify, next performed a hot-rolling process, a surface cutting process, a rolling process, an annealing and pickling process, subsequently a cleaning process, and so on to obtain a metal foil. Extra surface treatment process, such as a roughening treatment, a rustproofing treatment, or a plating treatment for forming other metal conductive layers thereon, can be applied on the metal foil in a roll-to-roll manner. The manufacturing method of the rolled metal base 102 is simple, of lower cost, and suitable for mass production. In some embodiments, the surface roughness of the rolled metal based film 102 can be controlled with a chemical etching process to increase an adhesion between the rolled metal based film 102 and a subsequently stacked material, and provide good adhesion. The rolled metal based film 102 can be a flexible base, for example, can be bendable, foldable, rollable, or durable to a high temperature in manufacturing process (for example, copper can withstand up to about 1000° C.). The rolled metal based film 102 has great flexibility in terms of use, and can be applied in various flexible as well as non-flexible electronic devices.

In some embodiments, the metal based film 102 can have a thickness of 1 μm-100 μm, such as 1 μm-10 μm. In some embodiments, when the metal based film 102 has a thickness of 6 μm-10 μm, the metal based film 102 has better supportability but may be not easy to etch. In some embodiments, when the metal based film 102 has a thickness of 1 μm-6 μm, the metal based film 102 is easy to etch but may have poorer supportability. In some embodiments, the metal based film 102 can have a thickness of 10 μm-20 μm. In other embodiments, the thickness of the metal based film 102 can be adjusted according to metal material for the metal based film 102 and requirements of the touch device to be manufactured, or can be adjusted to suit with requirements in the manufacturing process.

The rolled metal based film 102 can have a low resistance (such as 0.01 ohm/sq.-30 ohm/sq., or such as 10 ohm/sq.-30 ohm/sq.). For example, the rolled metal based film 102 may include aluminum (Al), copper (Cu), gold (Au), iron (Fe), nickel (Ni), silver (Ag), an alloy formed thereof (such as CuNi), or other metal materials suitable to be formed using the rolling process. According to some embodiments of the invention, in order to achieve composite materials with particular metallographic surface, an additional metal layer using a rolling process or a non-rolling process can be disposed on the rolled metal based film. Such additional metal layer and the rolled metal based film can be formed of the same metal or different metals.

Some properties of the rolled metal based films are listed in Table 2, wherein the unit of resistivity is Q-cm, the unit of density is oz/ft², the unit of hardness is Brinell hardness, and the unit of thermal conductivity is cal,sec,cm/° C. However, the rolled metal based film used in the present disclosure is not limited thereto.

TABLE 2

| | Aluminum | Copper | Gold | Iron | Nickel | Silver |
|---|---|---|---|---|---|---|
| Resistivity | 2.8 | 1.7 | 2.4 | 10.0 | 6.8 | 1.7 |
| Density | 0.22 | 0.74 | 1.6 | 0.64 | 0.74 | 0.87 |
| Hardness | 15 | 42 | 28 | 80 | 110 | 95 |
| Thermal | 0.84 | 0.92 | 0.70 | 0.16 | 0.14 | 0.97 |
| conductivity | | | | | | |

Referring to FIG. 2, a conductive layer 104 is formed on the rolled metal based film (metal substrate) 102 to form a laminated structure 108. The conductive layer 104 can be transparent or non-transparent. The conductive layer 104 may include a metal oxide, a conductive polymer, a conductive glass, a conductive nanotube, a conductive nanowire, a graphene, a metal mesh, other suitable conductive materials, or a combination thereof. However, the invention is not limited thereto.

For example, examples of the metal oxide can be indium tin oxide (ITO) or indium tin gallium zinc (IGZO).

For example, the conductive polymer suitable in the present disclosure may include poly (3,4-ethylenedioxythiophene)-poly (styrenesulfonate); PEDOT-PSS). PEDOT has a structural formula of:

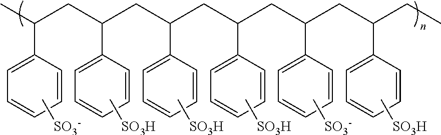

PSS has a structural formula of:

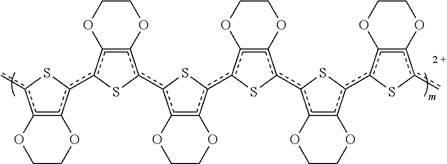

PEDOT-PSS is an aqueous solution of polymer with high-conductivity, and is composed of PEDOT and PSS. Based on different mixture formulas, different polymer aqueous solutions with different conductivities can be obtained. PEDOT-PSS has a transmittance (T.T %) above 80% and is flexible. For example, after being folded, PEDOT-PSS can still possess good conductivity and the resistance is increased with an extent less than 10%.

The conductive glass may include fluorine doped tin oxide (FTO). Raw materials (tin (Sn) and fluorine (F)) for FTO are cheap, and FTO has good thermal stability, optical stability, mechanical durability and chemical durability. For example, the manufacturing method of FTO includes following steps: After a tin tetrachloride (SnCl₄) aqueous solution is mixed with an indium nitrate (III) (In(NO₃)₃) or a hydrofluoric acid (HF) aqueous solution, acetylene black is added to the mixed solution to obtain a paste. Then, an ammonium hydroxide (NH₄OH) aqueous solution is added to the paste. After a sol gel process, a heat-treatment for drying the solvent is performed to obtain FTO powders.

The conductive nanotube may include a carbon nanotube (CNT) or other conductive materials that can be nanotube structures.

The conductive nanowire may include a silver nanowire (AgNW), or other conductive materials that can be nanowire structures. The silver nanowire is flexible and has low impedance (<50 ohm/square) and a high transmittance (T.T %) greater than 90%. After the silver nanowire is folded, the resistance is increased with an extent less than 10%.

Referring to FIG. 3, a base structure 110 is provided. In some embodiments, the base structure 110 may include a display structure, such as a liquid crystal display (LCD) device, an active-matrix organic light-emitting diode (AMOLED) display device, or other types of flexible or non-flexible display devices, and is not limited thereto. A transparent dielectric bonding layer 106A can be disposed on the conductive layer 104 of the laminated structure 108, and a transparent dielectric bonding layer 106B can be disposed on the base structure 110. The transparent dielectric bonding layers 106A and 106B can be formed of the same material or different materials. Depending on actual needs, the transparent dielectric bonding layers 106A and 106B can use suitable materials. For example, the transparent dielectric bonding layers 106A and 106B may include a ceramic material, a polymer material, or other suitable dielectric materials, and are not limited thereto. These materials can have viscosity.

In an embodiment, the transparent dielectric bonding layers 106A and 106B can have a transmittance near to that of a glass, and can have high transmittance. The dielectric constant of the transparent dielectric bonding layers 106A and 106B can be adjusted according to the desired capacitance of the product. For example, the dielectric constant can be between 2 and 9 or other suitable values, and is not limited thereto.

In an embodiment, the transparent dielectric bonding layers 106A and 106B adopting the ceramic material can be suitable for manufacturing a non-flexible touch device. The ceramic material suitable for the transparent dielectric bonding layers 106A and 106B can be a liquid ceramic material, such as liquid silicon material. The liquid silicon material can include a spin-on-glass (SOG), ceramic materials containing hydrogen silsesquioxane (HSQ), methysilsesquioxane (MSQ), or other materials.

The thicknesses of the transparent dielectric bonding layers 106A and 106B can be controlled through process parameters for forming the spin-on-glass. For example, the thickness of transparent dielectric bonding layers 106A and 106B are depending on actual needs. The transparent dielectric bonding layers 106A and 106B can be a thick film with thickness between 3 um to 6 um, or a thin film with thickness between 100 nm to 300 nm.

The spin-on-glass may include borosilicate glass (BSG) or a silica-related mixture. For example, spin-on-glass contains silica and 4%-5% of boron to mix in a volatile solvent. The boron enables the glass to flow at a high temperature, such that the glass can be uniformly coated and form a flat surface. In an embodiment, the dielectric constant can be 2-5, such as 3.9-4.5.

In some embodiments, hydrogen silsesquioxane (HSQ) (the hydrogen-containing silicate salt) can use an inorganic material of the Dow Corning Corporation which has a low dielectric constant, have a Si—O bond as a main structure, and have a molecular formula of (HSiO_{3/2})₂ₙ, wherein n=2, 3, 4. The preparation method of HSQ includes the following steps. A solution using a methane isobutyl ketone as a solvent is spin-coated as a layer. The layer is baked and cured at a temperature of about 400° C. The chemical structure changes to a network structure from a cage-like structure.

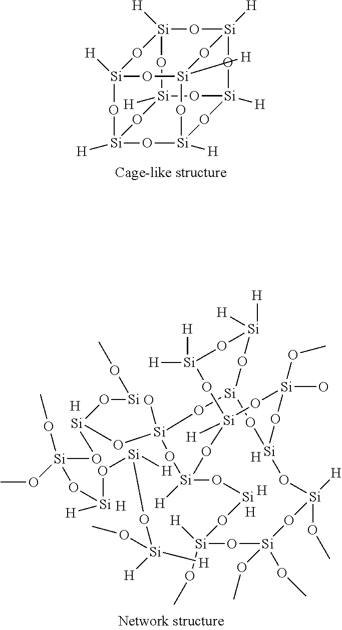

The molecular formula of the methysilsesquioxane (MSQ) is similar to that of HSQ, wherein hydrogen is replaced with a methyl group. The chemical formula of MSQ can be expressed as CH₃SiO_{1.5}. MSQ does not contain a Si—OH group, and therefore is not hydrophilic. By replacing —H with —CH₃, the dielectric constant of MSQ can be reduced. After suitable baking and curing treatments, the dielectric constant of MSQ is 2.7-3.0. MSQ can possess better thermal stability, chemical stability, and toughness than HSQ.

In an embodiment, the transparent dielectric bonding layers 106A and 106B adopting the polymer material can be used for manufacturing a flexible touch device. Suitable examples of the polymer material may include an organosilicon material, an acrylic resin, or a polyimide. The organosilicon material can be poly(dimethylsiloxane) (PDMS) whose structural formula can be expressed as:

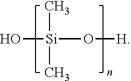

The density of PDMS is about 965 kg/m³. and PDMS has a good translucency. For example, PDMS can be bonded with a heterogeneous material at a room temperature by an oxygen plasma (O₂ plasma). PDMS has a low Young's modulus, therefore has a high structural flexibility.

Referring to FIG. 4, the transparent dielectric bonding layer 106B on the base structure 110 and the transparent dielectric bonding layer 106A on the laminated structure 108 are face to face.

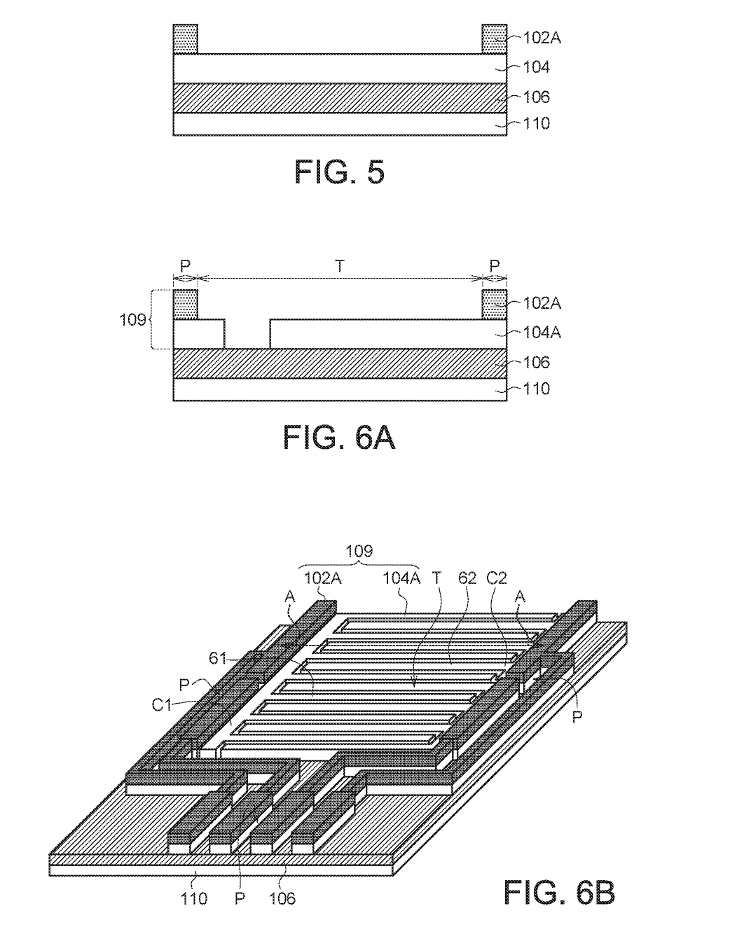

Referring to FIG. 5, the base structure 110 and the laminated structure 108 are bonded through a transparent dielectric bonding layer 106 (including transparent dielectric bonding layers 106A and 106B) (FIG. 4). Based on the properties of the material, the transparent dielectric bonding layer 106 (or the transparent dielectric bonding layers 106A and 106B of FIG. 4) can be proceeded with a suitable surface treatment, such as a heat treatment, a plasma treatment, an atmospheric treatment, an illumination treatment, etc., to generate an irreversible bonding effect and produce good adhesion effect. In other embodiments, a transparent dielectric bonding layer can be disposed on one of the base structure 110 and the laminated structure 108 for bonding the laminated structure 108 and the base structure 110.

Referring to FIG. 5, after the base structure 110 and the laminated structure 108 are bonded together, the metal based film (substrate) 102 (FIG. 4) is patterned to form a metal trace 102A. In some embodiments, the metal trace 102A can use a rolled metal. In some embodiments, the rolled metal trace 102A can have a thickness of 1 μm-100 μm, such as 1 μm-10 μm or 10 μm-20 μm. In some embodiments, the rolled metal trace 102A can have a thickness of 1 μm-6 μm or 6 μm-10 μm. The rolled metal trace 102A can have a roughness of 0.1 μm to several tens of μm, such as 0.1 μm-90 μm, 0.1 μm-50 μm, 5 μm-50 μm, 5 μm-30 μm, or 10 μm-25 μm. For example, the roughness of copper is 15 μm-20 μm.

Referring to FIG. 6A, the conductive layer 104 (FIG. 5) is patterned to form a touch electrode pattern 104A. The process of patterning the conductive layer 104 is not limited. For example, the conductive layer 104 can be patterned by using a photolithography process or a laser etching process, or other methods. The rolled metal trace 102A can be a touch trace. The rolled metal trace 102A and the touch electrode pattern 104A form a touch structure 109. The touch structure 109 has a touch region T and a peripheral region P. The peripheral region P can surround the touch region T. The touch electrode pattern 104A can be in the touch region T and the peripheral region P. The rolled metal trace 102A can be in the peripheral region P. The rolled metal trace 102A can be on an edge of the touch electrode pattern 104A and be electrically connected to the touch electrode pattern 104A. Thus, electrical information can be transferred from the touch electrode pattern 104A to an integrated circuit (IC) (not shown) via the rolled metal trace 102A.

The pattern of the touch electrode pattern 104A is not subject to particular restrictions. In some embodiments of the present disclosure, based on the touch method and the touch principles, the pattern of the touch electrode pattern 104A can be designed to meet actual needs. For example, the touch device of the present disclosure can be a capacitive, a resistive touch device, a self-capacitive, or a mutual capacitive touch device. In an embodiment, for example, the pattern of the touch electrode pattern 104A can be designed as a pattern shown in FIG. 6B. FIG. 6A is a cross-sectional view along a cross-sectional line AA of FIG. 6B. The touch electrode pattern 104A may include several touch channels. Each of the touch channels can have a finger-shape composed of one trunk and many branches. To simplify the illustration, FIG. 6B only shows two touch channels C1 and C2 disposed oppositely. Extending strips 61 of the touch channel C1 can be staggered with extending strips 62 of the touch channel C2. The touch electrode pattern 104A can transmit a sensing signal to an integrated circuit (IC) (not shown) for signal analysis through the rolled metal trace 102A having low resistance or superior conductivity. In some embodiments of the present disclosure, the touch electrode may include a sensing electrode and a driving electrode. At least one of the sensing electrode and the driving electrode can be formed using the method disclosed in the present disclosure.

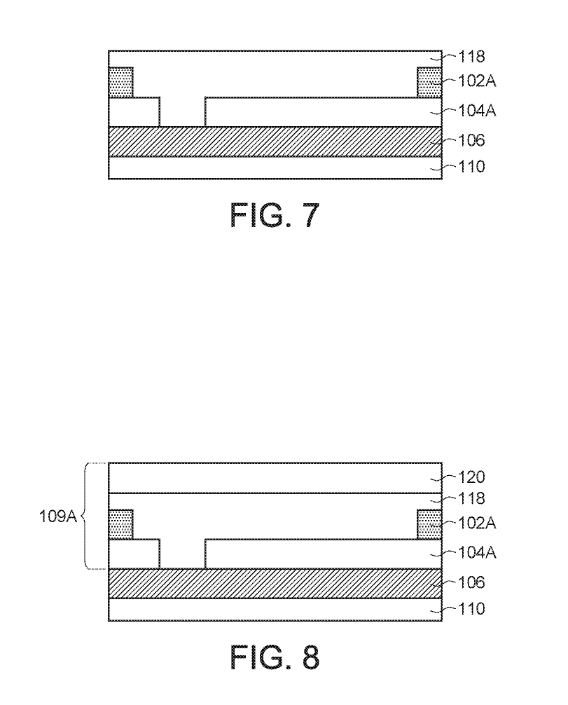

Referring to FIG. 7, a transparent bonding layer 118 can be disposed on the transparent dielectric bonding layer 106, the touch electrode pattern 104A and the rolled metal trace 102A.

Referring to FIG. 8, a protection layer 120 can be disposed on the bonding layer 118. The touch structure 109 including the electrode pattern 104A, the rolled metal trace 102A, a bonding layer 118 and a protection layer 120 can be bonded with the base structure 110 through the transparent dielectric bonding layer 106. In some embodiments of the present disclosure, the touch structure (109, 109A) (the touch panel module (TPM)) can be combined with any base structure through the transparent dielectric bonding layer 106 to form a touch device, such as an on-cell touch display device or an out-cell touch display device, and can be used in collaboration with a digitizer pen. For example, the base structure can be realized by a simple glass or plastic, such that the touch device of the present disclosure can be a touch panel which can be combined with any other display device to form an out-cell touch display device.

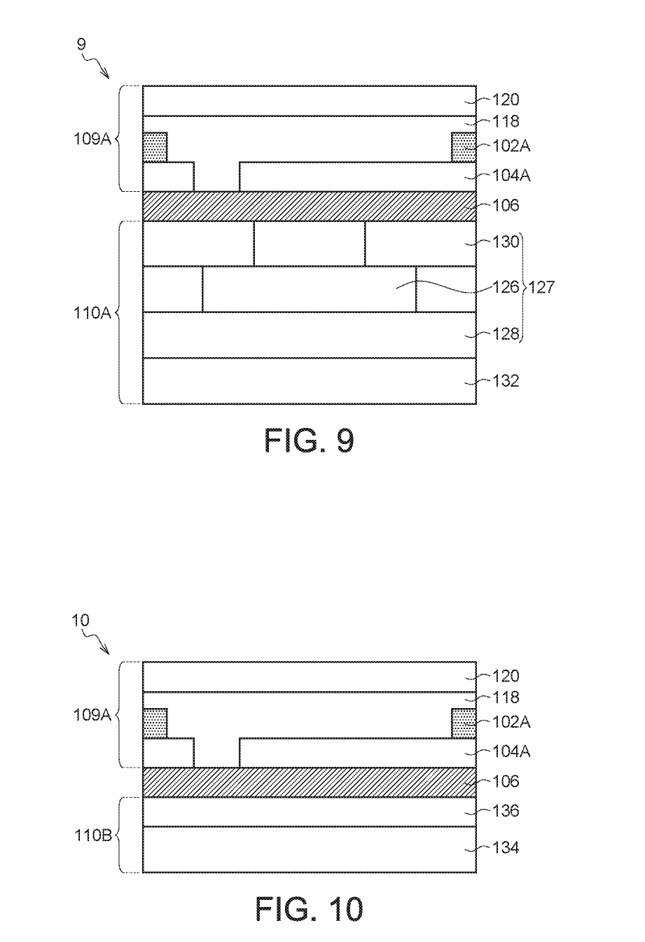

Referring to FIG. 9, a schematic diagram of a touch device 9 according to another embodiment is shown. As disclosed above, the touch structure 109A can be bonded with a base structure 110A through the transparent dielectric bonding layer 106 to form a touch structure 9. The base structure 110A can be a display structure, and thus the touch structure 9 is an on-cell (or touch on display (TOD)) touch display device. For example, the base structure 110A can be a liquid crystal display (LCD) device, which may include a LCD panel 127 and a backlight module 132 disposed oppositely. For example, the LCD panel 127 may include a thin-film-transistor (TFT) substrate 128, a color filter substrate 130, and a liquid crystal layer 126 between the TFT substrate 128 and the color filter substrate 130. In an embodiment, the transparent dielectric bonding layer 106 can use the foregoing ceramic material suitable for a non-flexible electronic device.

Referring to FIG. 10, a schematic diagram of a touch device 10 according to an alternate embodiment is shown. For example, a base structure 1106 may include an active-matrix organic light-emitting diode (AMOLED) display device 134, which can be a flexible or a non-flexible display device. A barrier layer 136 can be interposed between the OLED display device 134 and the touch structure 109A to avoid the infiltration of moisture. The barrier layer 136 can use a material such as an inorganic material, an organic material or a mixture of organic and inorganic materials. In an embodiment, for example, the transparent dielectric bonding layer 106 can use the foregoing polymer material. In an embodiment, the polymer material as the transparent dielectric bonding layer 106 can be combined with a flexible OLED display device and the touch structure 109A, thus forming the touch device 10 being a flexible touch display device.

In an embodiment, overall features of the touch display device, such as optical properties and materials, can be suitably adjusted depending on actual needs. The touch display device can pursue light weight, slim border, and can be easily embedded to various electronic devices, such as all-in-one PC (AIO PC).

According to the embodiments disclosed above, the touch device uses the metal based film as a base for supporting other material layer without using extra plastic base. Furthermore, the metal based film is patterned to form a rolled metal external trace of the touch structure, simplifying the manufacturing process, saving material, reducing cost or thinning the touch device. Besides, the rolled metal based film (or rolled metal external trace) is flexible, and therefore can be used in not only flexible touch device and touch display device, but also non-flexible touch device and touch display device. The rolled metal based film can have great flexibility of use.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch device, comprising:
a base structure; and
a touch structure, comprising:
a touch electrode pattern on the base structure; and
a metal trace on an edge of the touch electrode pattern, wherein a thickness of the metal trace is 1 μm-100 μm, a roughness of the metal trace is 0.1 μm-90 μm.

2. The touch device according to claim 1, wherein the thickness of the metal trace is 1 μm-10 μm.

3. The touch device according to claim 1, wherein the thickness of the metal trace is 6 μm-10 μm.

4. The touch device according to claim 1, wherein the thickness of the metal trace is 10 μm-20 μm.

5. The touch device according to claim 1, wherein the roughness of the metal trace is 5 μm-50 μm.

6. The touch device according to claim 1, further comprising a transparent dielectric bonding layer between the base structure and the touch electrode pattern.

7. The touch device according to claim 6, wherein the transparent dielectric bonding layer comprises a ceramic material or a polymer material.

8. The touch device according to claim 7, wherein the ceramic material comprises a spin-on-glass (SOG).

9. The touch device according to claim 7, wherein the polymer material comprises an organosilicon material, an acrylic resin, or a polyimide.

10. The touch device according to claim 1, wherein the base structure comprises a display structure.

11. The touch device according to claim 1, wherein the touch electrode pattern comprises a conductive polymer, a conductive glass, a conductive nanotube, a conductive nanowire, a graphene, or a metal mesh.

12. The touch device according to claim 1, wherein the metal trace is a rolled metal.

13. The touch device according to claim 1, wherein the metal trace is electrically connected to the touch electrode pattern.

14. A manufacturing method of a touch device, comprising:
forming a conductive layer on a metal substrate to form a laminated structure;
providing a base structure;
bonding the conductive layer of the laminated structure and the base structure through a transparent dielectric bonding layer;
patterning the metal substrate to form a metal trace of the touch device; and
patterning the conductive layer to form a touch electrode pattern of the touch device.

15. The manufacturing method of the touch device according to claim 14, further comprising a step of forming the metal substrate, wherein the metal substrate is formed by rolling.
